(19) United States
(12) Patent Application Publication
(10) Pub. No.: US 2007/0202804 A1
(43) Pub. Date: Aug. 30, 2007

(54) Satellite signal relay and receiver

(75) Inventor: Frank A. Vassallo, Tamarac, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: VRD Technologies, Inc., Tamarac, FL (US)

(21) Appl. No.: 11/365,647

(22) Filed: Feb. 28, 2006

(51) Int. Cl. H04B 7/185

(52) U.S. Cl. 455/13.1

(57) ABSTRACT

An apparatus, system, and method are provided for terrestrially retransmitting and receiving a satellite-transmitted television signal within a building. The system includes a relay stage with an input for receiving a satellite-transmitted television signal, an amplifier, and a filter, wherein the relay stage retransmits a portion of the signal in, for example, a right-hand polarization and a portion of the signal in a left-hand polarization. The system further includes a receiver stage that receives the right-hand polarized signal and the left-hand polarized signal and outputs a television signal to a satellite set-top receiver box. The present invention also relays satellite-transmitted radio signals.

### BACKGROUND OF THE INVENTION

1. Field of the Invention

The present invention relates generally to the relay of satellite signals, and more particularly pertains to wirelessly relaying satellite signals within a building.

2. Description of the Related Art

Satellite transmission has quickly become a commercially viable method of wirelessly transmitting television signals directly to the homes of each member of a distributed group of subscribers. A satellite transmission system generally includes a group of geosynchronous transmitters orbiting the Earth. In a geosynchronous orbit, the satellites remain in one position in the sky relative to the Earth, which allows antennas at the terrestrial receivers to remain in alignment with the orbiting transmitters without the need for further adjustment. Satellites advantageously overcome traditional line-of-sight transmission limitations, which include short range, distortion, and multi-path fading, by placing the transmitter above the receiver. Each orbiting satellite transmitter is arranged and spaced away from the other satellites so as to cover a certain portion of the earth's surface. The entire satellite system provides coverage to a very large geographic area that includes virtually, or literally, the entire planet, depending on the number of satellites and transmission strength.

Many satellite TV subscribers get their programming through a direct broadcast satellite (DBS) provider, such a DirecTV or the Dish Network. The providers compete with cable TV providers by selecting hundreds of programs and broadcasting them to subscribers as a package.

Current direct to home (DTH) satellite systems are composed of five main components: the programming source, the broadcast center, the satellite, the satellite dish, and the receiver. The five components are illustrated in FIG. 1. A programming source 102 is one or more channels 104a-104n that are broadcast by the provider. Exemplary channels are the Discovery Channel, HBO, Showtime, MTV and others. A broadcast center 106 transmits the programming sources to the satellites 108a-108n in their geostationary orbits. Generally, only a subset of the orbiting satellites receive their signals from the broadcast center 106. The subset of the satellites 108a-108n communicate the signals to the other satellites and rebroadcast them back down to Earth 110. The result is that the signal originated at a broadcast center 106, which is generally a single point, is broadcast to a vast terrestrial geographic receiving area.

At the subscriber's location 112, a dish antenna 114, located on the outside of a building 116, receives the airborne signal 118 and passes it along wires 120 that penetrate into the subscriber's building 116 to a receiver 122 in the subscriber's dwelling area 124. The receiver 122 processes the signal and passes it on to a television 126.

The receiver extracts individual channels from the larger composite satellite signal. When a channel is changed on the receiver, only the signal for that channel is output from the receiver. In order to have access to multiple channels at each television in a building, a separate receiver must be coupled to each television.

Currently, a wired electrical path, e.g. 120, must be created from the dish antenna to each receiver. Wires—typically coaxial cable—must be physically run from the antenna located outside the building, through the walls, and into each room a television is located. Running cables through walls is a physically difficult task that often requires an installer to crawl through an attic and drop cables between the walls. Installation of cables also requires the drilling of holes in one or more walls. In some cases, running the wires through the roof or ceiling is not possible due to a low clearance between the ceiling and roof. In structures such as apartments or condominium buildings, there is little or no space between the vertically stacked units. This architecture makes running cables extremely difficult, expensive, or impossible.

Accordingly, a need exists to overcome the difficulties with providing a wired pathway from a satellite signal receiving antenna to each room a television is located within a building structure.

### SUMMARY OF THE INVENTION

Briefly, in accordance with one embodiment of the present invention, disclosed is an apparatus for terrestrially relaying satellite-transmitted signals. In one embodiment, the apparatus comprises an input for receiving a satellite-transmitted signal and an output for terrestrially wirelessly transmitting at least a portion of the signal to a receiver. The transmitted signal includes a left-hand polarized component and a right-hand polarized component.

In an embodiment of the present invention, the received satellite-transmitted signal includes a left-hand polarized component and a right-hand polarized component that correspond to the left-hand polarized component and the right-hand polarized component of the transmitted signal.

In one embodiment of the present invention, the input and output are within, or at least attached to, a building.

In another embodiment of the present invention, the output has a helix antenna, a crossed-dipole antenna, or a parabolic antenna to launch the output signal into free space.

An alternative embodiment of the present invention includes an encoder for encoding the satellite-transmitted signal before the output terrestrially wirelessly transmits the output signal.

In one embodiment of the present invention, the input and output frequencies are substantially the same so that the output transmits the left-hand polarized component and the right-hand polarized component at substantially the same radio frequency as the input receives the satellite-transmitted signal.

In yet another embodiment of the present invention, the output signals are received within the building by a receiving stage that receives the wirelessly transmitted left-hand polarized component and the right-hand polarized component.

The invention includes an amplifier communicatively coupled to the input for amplifying the received satellite-transmitted signal, which includes television signals.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating a prior-art satellite system.

FIG. 2 is a diagram illustrating a dual polarization satellite transmission to a terrestrial antenna.

FIG. 3 is a diagram illustrating one embodiment of a satellite signal relay system in accordance with the present invention.

FIG. 4 is a diagram illustrating one embodiment of a first stage of the satellite signal relay system shown in FIG. 3, in accordance with the present invention.

FIG. 5 is a diagram illustrating one embodiment of a second stage of the satellite signal relay system shown in FIG. 3, in accordance with the present invention.

FIG. 6 is a diagram illustrating one embodiment of a modified low noise block, in accordance with the present invention.

FIG. 7 is a diagram illustrating a second embodiment of a first stage of the satellite signal relay system shown in FIG. 3, in accordance with the present invention.

FIG. 8 is a diagram illustrating a second embodiment of a second stage of the satellite signal relay system shown in FIG. 3, in accordance with the present invention.

FIG. 9 is a flow diagram of a process of terrestrially relaying a satellite-transmitted signal, in accordance with a preferred embodiment of the present invention.

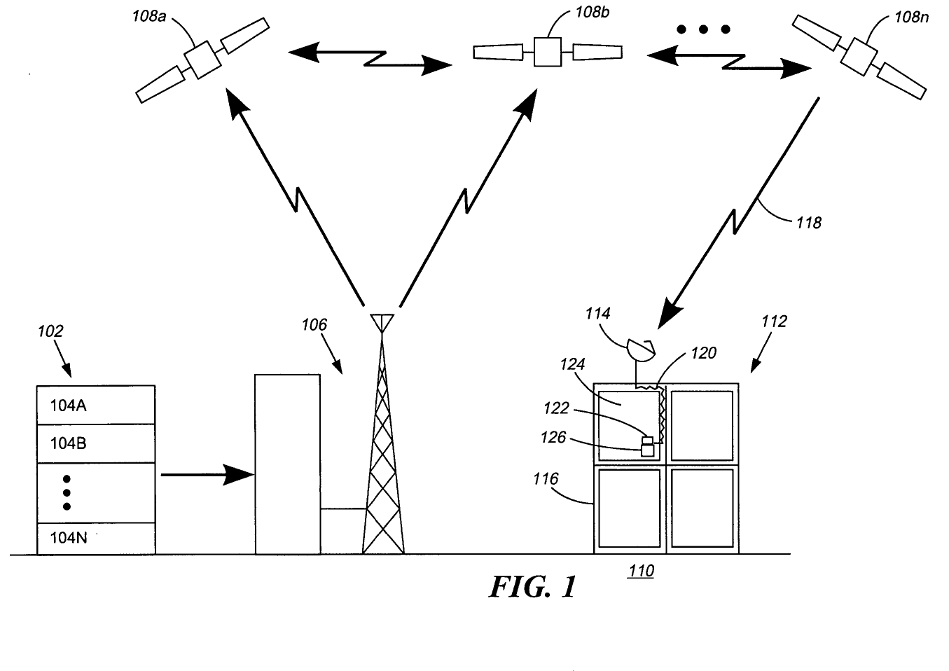

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to one embodiment, overcomes problems with the prior art by wirelessly relaying a satellite signal received at a terrestrial antenna to one or more terrestrial receiving locations within a building, thereby obviating in-building cabling.

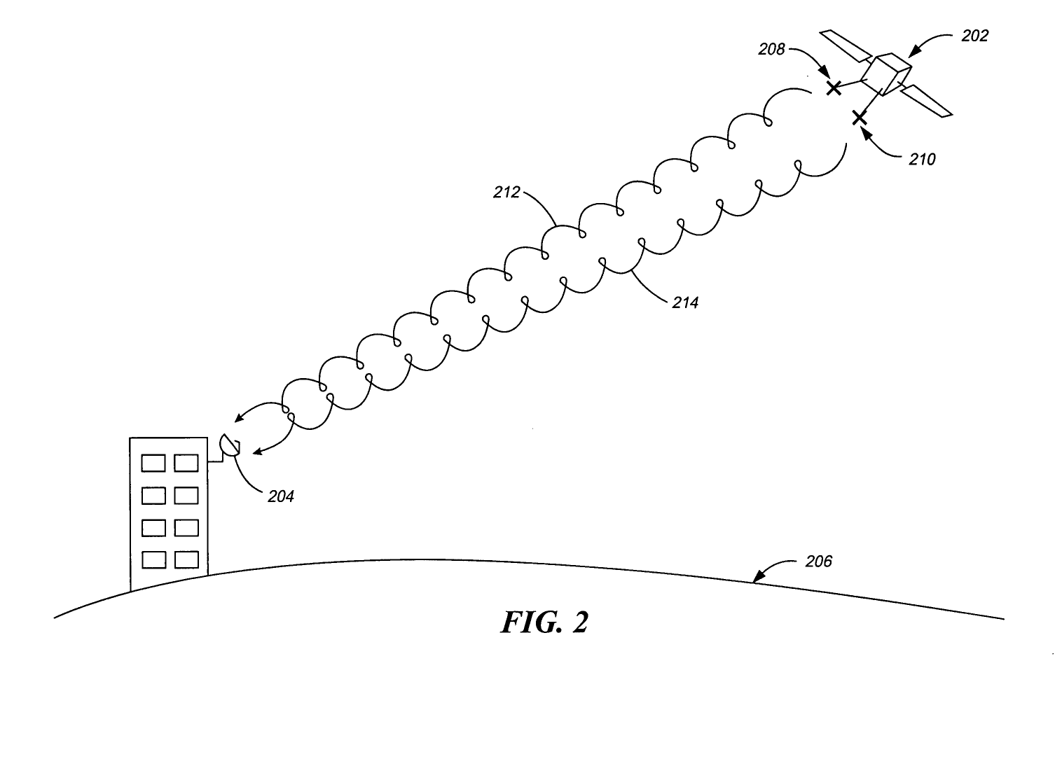

Described now is an exemplary apparatus according to one embodiment of the present invention. Referring now to FIG. 2, an exemplary satellite 202 is shown in a geostationary orbit in relation to the Earth 206. The satellite 202 represents a single satellite that can be a member of a much larger group of satellites.

One of the characteristics of antenna transmission is “polarization,” which describes what physical plane the signal is being transmitted in. Communication from a satellite to terrestrial receivers is often accomplished with radiating elements commonly called “dipoles.” A dipole has two elements of equal size arranged in a shared axial alignment configuration with a small gap between the two elements. Each element of the dipole is fed with a charge 180 degrees out of phase from the other. In this manner, the elements will have opposite charges and common nulls.

A dipole oriented in a vertical position radiates signals in a vertical polarization. Similarly, a dipole oriented in a horizontal position radiates signals in a horizontal polarization. Satellite 202 is provided with a pair of perpendicularly oriented, or orthogonal, dipole antennas 208 and 210. The dipoles alternate “firing” with a positive charge rotating sequentially around the four individual elements and a negative charge on its axially oppositely aligned second element. When viewed on a three-dimensional time vs. polarization graph, the circularly polarized signal resembles a helix.

By utilizing crossed dipoles, a satellite is able to transmit signals in a “circular” polarization. The DBS antennas transmit their energy to earth in both a Left-Hand Circular Polarization (LHCP) and Right-Hand Circular Polarization (RHCP). The polarizations can be thought of as components of a single signal or two separate satellite-transmitted signals.

Each satellite in the DBS has two receiving and transmitting antennas. As is well known in the art of wireless transmission and reception, a receiving antenna that is horizontally polarized will receive little or no signal from a vertically polarized transmitting antenna. Conversely, a vertically polarized antenna will receive maximum signal strength from a vertically transmitting antenna. In one embodiment of the present invention, a satellite 202 transmits one set of signals in a horizontal polarization and a second set of signals in a vertical polarization. For instance, half of a set of channels is sent in a horizontal polarization and the other half in a vertical polarization. This is essentially similar to circular polarization. Except in circular polarization, the sending and receiving polarization is constantly changing. Although using both LHCP and RHCP increases the complexity of the home receiving antennas, it allows more channels to be broadcast in the same frequency band without interference and ensures that the signal is received on earth, regardless of the orientation of the receiving antenna, as the polarization will be lined up at least half of every cycle. In one embodiment, this same principle is used in the present inventive satellite relay system for transmitting high-bandwidth programming within a building. A “building” includes any structure, such as a home, apartment building, hotel, condominium, restaurant, and others.

In other embodiments, a pair of satellites can function as a coordinated pair, with one satellite transmitting a first group of channels in a first polarization and the second satellite transmitting a second group of channels in a second polarization. The signals from both satellites can be received by a single terrestrial receiving antenna. In the embodiment shown in FIG. 2, satellite 202 transmits a first group of channels 212 in a first polarization and a second group of channels 214 in a second polarization that is opposite the first polarization. These polarizations can be circular or linear. Due to the opposite polarizations of the two signals, the separate groups of channels can be received by the single dish antenna 204 with little or no interference between the signals. It should be noted that other structures and methods of transmitting and receiving polarized signals are within the spirit and scope of the invention and the invention is not limited to those shown and described herein.

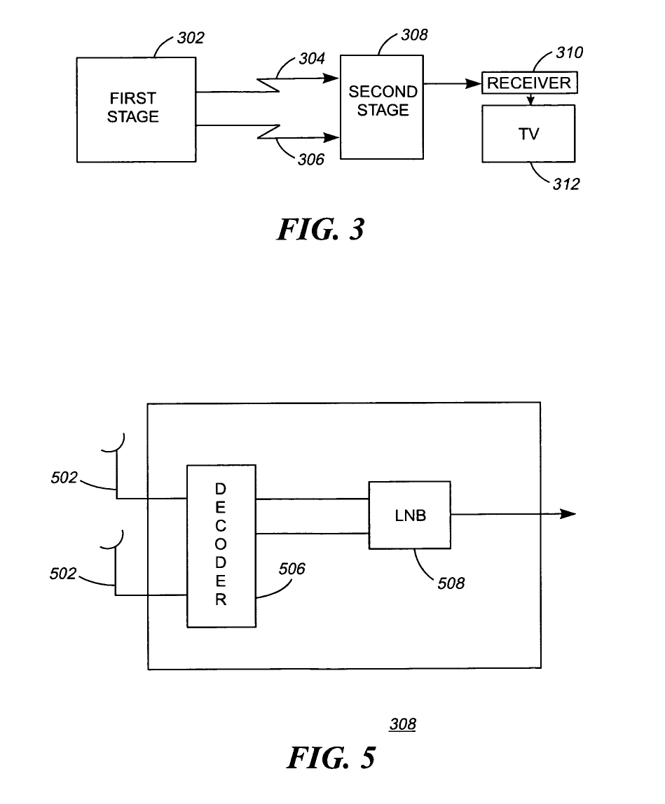

FIG. 3 shows a block diagram of one embodiment of a satellite signal relay system according to the present invention. The frequency band allocated to DBS is between 12.2 and 12.7 gigahertz (GHz). This band carried television channel programming information as well as other information, such as music. A first stage 302 amplifies radio signals caught by the dish antenna 204 and filters out the noise (radio signals not in the DBS frequency range). The first stage 302, in one embodiment, encodes the signals and wirelessly transmits a portion of the amplified encoded signals along a right-hand circularly polarized wireless path 304 and a portion of the signals along a left-hand circularly polarized wireless path 306 to a second stage 308 within the viewer's house. In another embodiment, the first stage 302 wirelessly transmits a portion of the amplified encoded signals along a vertically polarized wireless path 304 and a second portion of the amplified encoded signals along a horizontally polarized wireless path 306 to the second stage 308. The second stage 308 decodes the signals, performs further filtering, and passes the signals to a set-top receiver 310 coupled to a television 312.

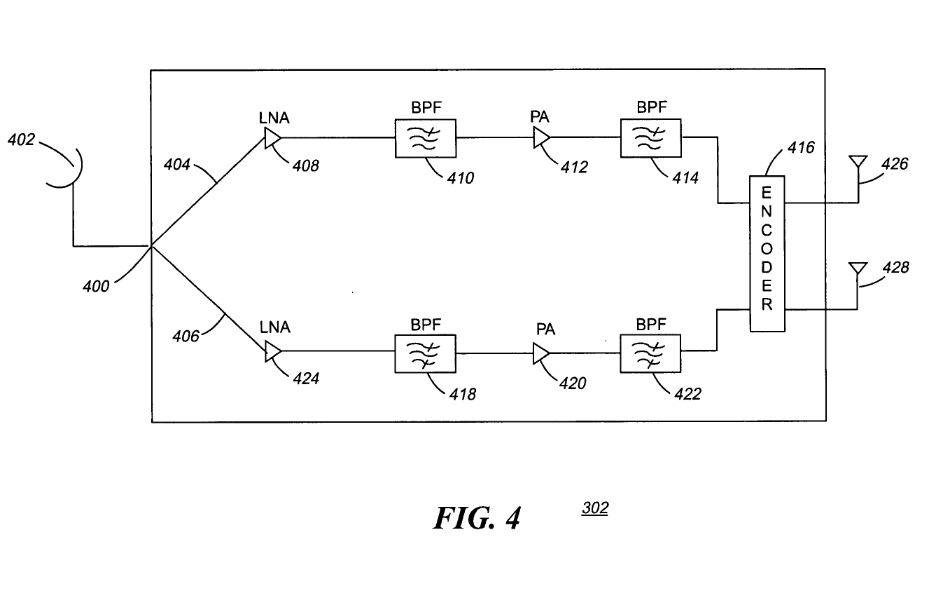

FIG. 4 is a schematic diagram of the first stage 302. At the input 400 of the first stage 302 is the left and right hand circularly polarized signals output from a receiving antenna 402, which is typically located outside a building. In one embodiment, the signals are delivered to the input 400 via cables or wires. In other embodiments, the first stage is located within or coupled to the antenna 402 outside a building and the signals are wirelessly broadcast from an output of the first stage into the building.

In addition to the signals 212 and 214 transmitted by the orbiting satellite 108a-108n, as shown in FIG. 2, other signals, or noise, are received at the dish antenna 402, which need to be separated out. Once input to the first stage 302, the left-hand polarized signal and the right-hand polarized signal are separately provided to one of two different paths 404 and 406. Following the first pathway 404, the signal reaches a low noise amplifier (LNA) 408. An LNA is a special type of electronic amplifier used in communication systems to amplify very weak signals captured by an antenna. It is a key component, which is usually placed at the front-end of a receiver system. Using an LNA, the noise contribution of all the subsequent stages is effectively reduced by the gain of the LNA and the noise of the LNA is injected directly into the received signal. Thus, it is desirable for a LNA to boost the signal power while adding as little noise and distortion as possible so that the retrieval of this signal is possible in the later stages in the system. In the exemplary circuit of FIG. 4, the LNA 408 amplifies the input signal and outputs the boosted signal to a band pass filter (BPF) 410. A BPF is a device that passes frequencies within a certain range and rejects or at least attenuates frequencies outside that range. In the exemplary circuit, frequencies outside the 12.2 to 12.7 GHz band are rejected by the BPF 410. Because no filter is ideal, there is a region (known as the filter roll-off region) just outside the intended pass band where frequencies are attenuated, but not rejected. The filter is chosen so as to make the roll-off as narrow as possible. It should be noted that other types of filters can be used in accordance with the present invention.

After exiting the BPF 410, the signal contains frequencies in the range of about 12.2 to 12.7 GHz. The signal is then input to a power amplifier (PA) 412, which boost the power of the entire frequency range. It should noted that other types of amplifiers can also be used or used instead of the power amplifier. The boosted signal is output from the PA 412 and input to the second band pass filter (BPF) 414, which provides further filtering of the pass band and intermodulation products of the PA 412. Before being wirelessly transmitted, the signal, in one embodiment of the present invention, is encoded by an encoder 416. The encoder 416 encodes the signal into a form that is acceptable for transmission. The encoder is controlled by a microprocessor and the encoding, in one embodiment of the present invention, is done by means of a programmed algorithm. Well-known encoders and decoders are Holtek HT-12D, HT-12E and Motorola MC145026, MC145027, and MC145028. Encoding, however, is not necessary for the present invention.

After being encoded, the signal is then launched into free space again by an antenna 426. In an embodiment of the present invention, the antenna 426 retransmits the signal in a circularly polarized format. The polarization can be the same polarization received or in an opposite polarization. In other embodiments, the antenna 426 transmits in a linearly polarized format. For circularized polarization, the antenna 426 can be a crossed dipole, a helix, or any other antenna capable of launching a suitable signal into free space.

Going back to the input 400 of the first stage 302, the second signal follows a second pathway 406, which has similar components as does the first pathway 404. Following second pathway 406, the signal reaches an LNA 422. The LNA 422 outputs the boosted signal to a BPF 418. The filtered signal, which in one embodiment of the present invention, now only contains frequencies in the range of 12.2 to 12.7 GHz, is input to a PA 420, which boosts the power of the entire frequency range. The boosted signal is output from the PA 420 and input to a second BPF 422, which provides further filtering of the pass band. Before being wirelessly transmitted, the signal, in one embodiment of the present invention, is encoded by the encoder 416. It should be noted that encoding is not a necessary part of the present invention.

After being encoded, the signal is then launched into free space again by an antenna 428. In an embodiment of the present invention, the antenna 428 retransmits the signal in a circularly polarized format. The polarization can be the same polarization received, a polarization opposite of the polarization received, and is preferably opposite to the polarization of the signal transmitted on antenna 426. In other embodiments, the antenna 428 transmits in a linearly polarized format. For circularized polarization, the antenna 428 can be a crossed dipole, a helix, or any other antenna capable of launching a suitable signal into free space. The term “circular polarization” includes any rotating polarization, including elliptical.

The signals are transmitted across whatever distance is necessary to reach the second, or receiver, stage 308. In an embodiment of the present invention, the signals are transmitted through, around, or between walls within a house to multiple second stages 308 so that satellite television reception is available at each television within a house. All broadcast channels of conventional and high definition programming are made available at each television because the bandwidth of the satellite transmission band was not reduced in the first stage. The high-frequency signals are able to pass through walls or other obstacles because they have been amplified by the LNAs and PAs in the first stage 302. In other embodiments, the first stage is in a central location within a multi-unit dwelling and the satellite signals are relayed to subscribers in any of the units. The second unit performs a down-converting step that is normally performed by the set-top receivers in the traditional DBS system.

Turning now to FIG. 5, the signals transmitted by the first stage 302 are captured by a pair of antennas 502 and 504, which each have orthogonal polarization with respect to each other, on the second stage 308 and are decoded by a decoder 506. The decoder is a device that does the reverse of the encoder 416, undoing the encoding so that the original information can be retrieved. The same method used to encode is just reversed in order to decode. Of course, if no encoder 416 is present in the first stage 302, a decoder 506 in the second stage 308 is not necessary.

The decoded signals are then passed to a modified low noise block 508 (LNB). LNBs are commonly used in communications satellite (usually broadcast satellite) reception. The job of the LNB is to use the superheterodyne principle to take a wide block (or band) of relatively high frequencies, amplify and convert them to similar signals carried at a much lower frequency (called “intermediate frequency” or “IF”). These lower frequencies travel through cables with less attenuation of the signals. It is also much easier and cheaper to design electronic circuits to operate at these lower frequencies (rather than the very high frequencies of satellite transmission). The present invention breaks the function of a typical one-stage LNB into two stages; one at the relay 302 and the other at the receiving stage 308. Because the LNB of the present invention is split, LNB 508 is a modified version of a commonly-known LNB.

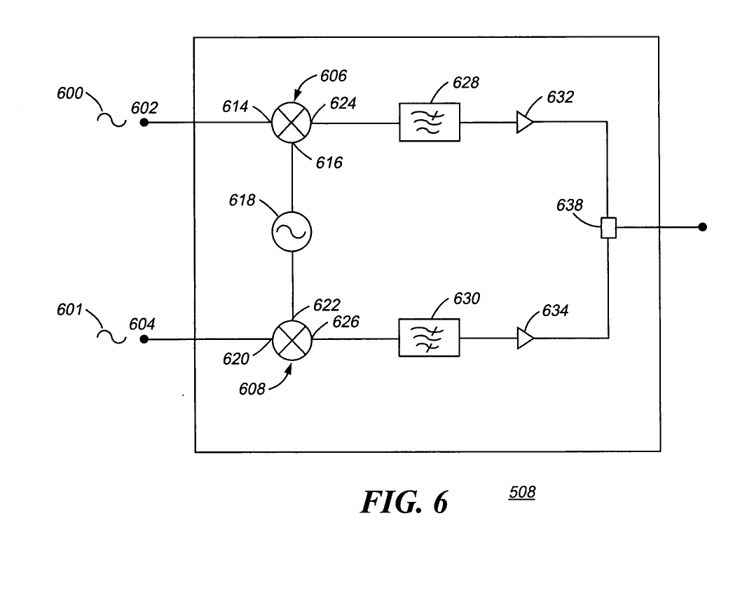

FIG. 6 shows a schematic diagram of the modified LNB 508. The modified LNB 508 accepts at a first input 602, which is a right-hand circularly polarized signal 600, and accepts at a second input 604, which is a left-hand circularly polarized signal 601. The signals at inputs 602 and 604 are then introduced to first and second mixers 606 and 608, respectively. The mixers 606 and 608 are nonlinear devices that each has three ports: a LO (local oscillator) port, an RF (radio frequency) port, and an IF (intermediate frequency) port. Each of the mixers 606 and 608 is coupled to an LO 618.

Mixer 606 has a first input 614 that receives the RF signal from the input 602 (coupled to the decoder 506) and a second input 616 that receives a signal from the LO 618. Mixer 608 has a first input 620 that receives the RF signal from the input 604 (coupled to the decoder 506) and a second input 622 that receives a signal from the LO 618.

The LO 618 produces a signal which is injected into the mixers 606 and 608 along with the decoded signals 600 and 601 from the antenna (at about 12.2 to 12.7 GHz). The LO 618 effectively changes the frequency of each of the signals 600 and 601 by heterodyning with each of them to produce a corresponding intermediate frequency (IF) which can be handled by a downstream IF amplifier. The IF signals are produced at the output 624 and 626 of mixers 606 and 608, respectively.

In one embodiment of the present invention, the IF output signals travel from the outputs 624 and 626 to bandpass filters 628 and 630, respectively. The filtered signals are then amplified by IF amplifiers 632 and 634 that boost the signals to a desired voltage. The amplified IF signals are then combined in combiner 638 and output from the modified LNB 508 to what, in one embodiment of the present invention, is a known set-top receiver. In other embodiments, the modified LNB 508 includes switch circuit so that the amplified IF signals are run through additional stages, such as splitters and/or switching stages so that the right-hand polarized signal and the left-hand polarized signals can be individually selected and-or combined before being output to a set-top receiver box.

A set-top receiver box 310, shown in FIG. 5, is the end component in the entire satellite TV system. The satellite signal is typically scrambled so that only subscribers can view the programming. The receiver 310 de-scrambles the encrypted signal. The receiver 310 is also able to take a digital MPEG-2 signal and convert it into an analog format that a standard television can recognize. Some dish and receiver setups can also output an HDTV signal. Additionally, the receiver 310 extracts the individual channels from the larger satellite signal. When the channel is changed on the receiver 310, the receiver sends just the signal for that channel to the television.

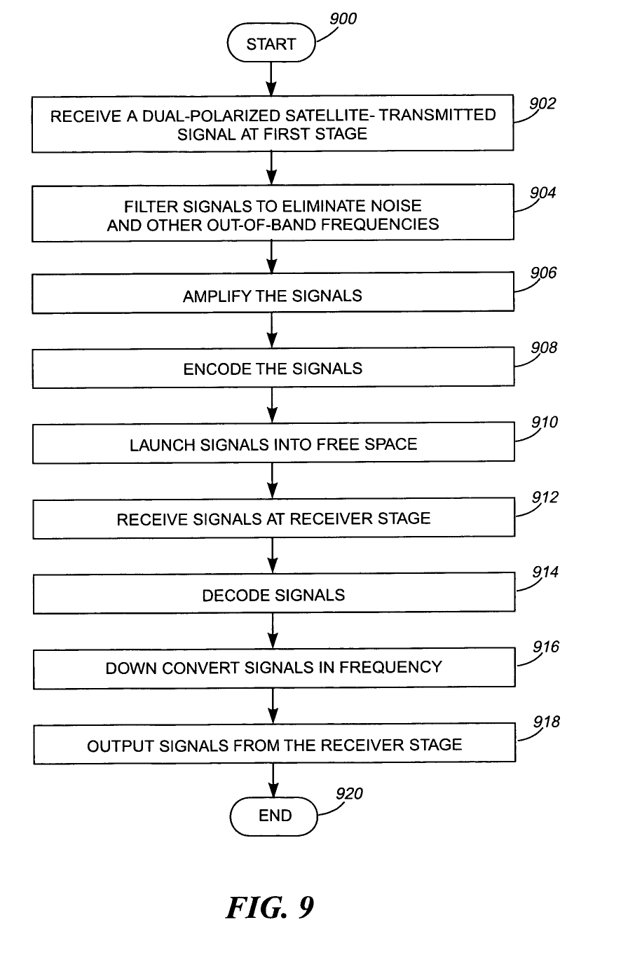

FIG. 9 is a flow diagram illustrating a process according to one embodiment of the present invention. The flow begins at step 900 and moves directly to step 902 where a dual-polarized satellite-transmitted signal is received at an input of a first stage. The signals are then filtered to eliminate noise and other out-of-band frequencies in step 904. In step 906, the signals are amplified. Next, in step 908, the signals are encoded. The signals are then launched into free space, in step 910, via one or more antennas. In step 912, the signals are received at a receiver stage. The signals are decoded in step 914 and then introduced to a LNB, where they are down converted in frequency at step 916. Next, the signals are output from the receiver stage 918. The process ends at step 920.

As should be obvious from the description above, a novelty of the present invention is that at least two received circularly polarized signals carrying television channel information are completely retransmitted, or relayed, from a first stage to a second stage within the same building at the signals' original satellite-transmitted frequencies. The signals are down converted to an IF at the second stage, which is in wireless communication with the first stage and output to a set-top receiver box. The above-described and illustrated circuits and devices are exemplary and the invention is not so limited. Amplifying and filtering devices and circuits are not required for operation of the present invention and, if used, can be placed at locations in the circuit other than those shown and described herein. Furthermore, it is clear that embodiments of the present invention are able to operate at any RF frequency.

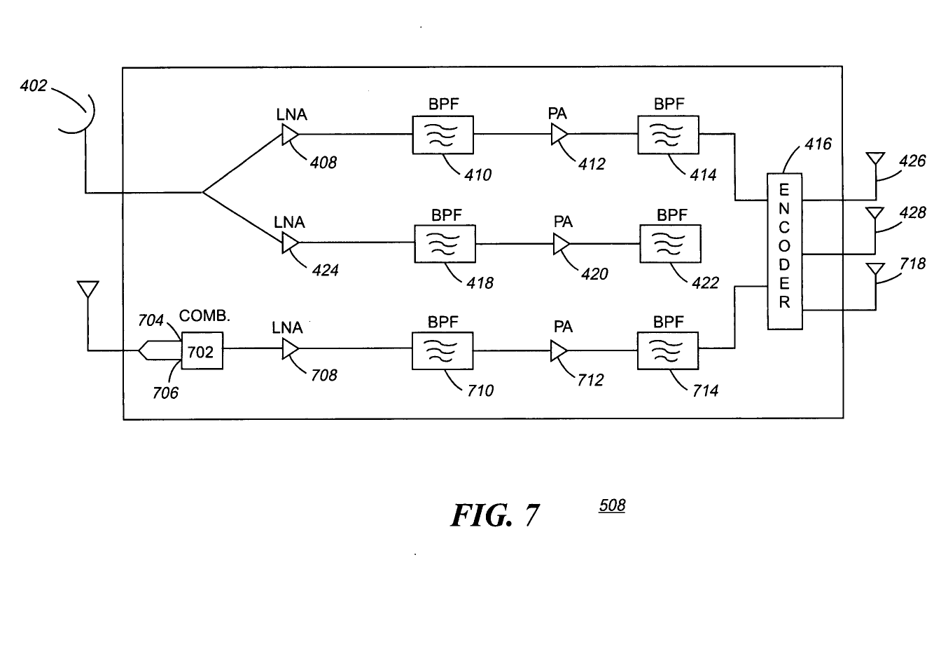

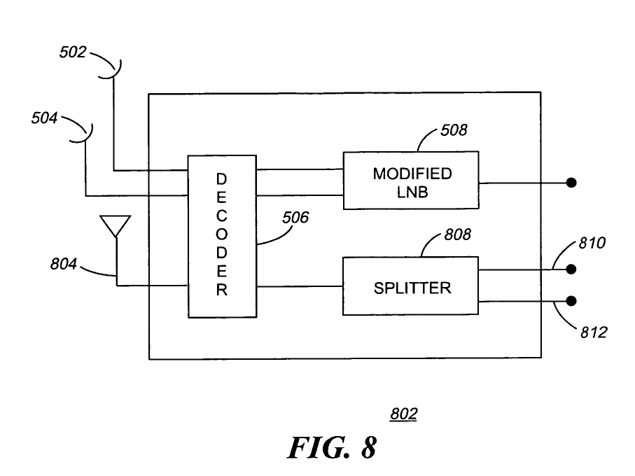

In another embodiment of the present invention, shown in FIG. 7, the first stage similar to that illustrated and discussed above is augmented so as to be is operable to also receive one or more satellite-transmitted radio signals, such as SIRIUS (2.3200 to 2.3325 GHz) or XM (2.3355 to 2.3450 GHz). Looking at FIG. 7, a combiner 702 has two inputs 704 and 706. Each input 704 and 706 can receive a signal at a specific frequency range or at any satellite transmitted frequency range. In an embodiment of the present invention, the radio signals follow a path similar to the television signals described above and are amplified, filtered, and relayed to a second receiver. In this embodiment, the radio signals are combined by the combiner 702 and output as a single signal to a LNA 708 which boosts the signal power. The amplified signal is then run through a BPF 710 to attenuate frequencies that are not in the desired satellite radio band. The filtered signals are then amplified by a power amplifier 712 to boost the signals for later wireless transmission to a second stage. Before transmission, however, the signal receives additional filtering by a BPF 714 and is encoded by the encoder 416 for secure transmission. After encoding, the signal is transmitted via transmitting antenna 718 to a second stage 802, shown in FIG. 8. It should be noted that the encoder 416 provides secure transmission of the signals, but is not necessary and the present invention can be used without it.

At the second stage 802, that operates with the alternative embodiment, the retransmitted satellite transmitted radio signal is received with an antenna 804 and decoded with the decoder 506 and is then input to a splitter 808, which separates the previously combined radio signals. The separated signals are output, each on one of two outputs 810 and 812. As should be clear to those of skill in the art, in light of the present discussion, more or less than two radio signals can be received and relayed with the present invention.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

What is claimed is:

1. An apparatus for terrestrially relaying satellite-transmitted signals, the apparatus comprising:
an input for receiving a first portion of a satellite-transmitted signal in a first polarization and a second portion of the satellite-transmitted signal in a second polarization that is orthogonal to the first polarization; and
an output for terrestrially wirelessly transmitting a first transmitted portion of the satellite-transmitted signal in a first transmitted polarization and for terrestrially wirelessly transmitting a second transmitted portion of the satellite-transmitted signal in a second transmitted polarization that is orthogonal to the first transmitted polarization.

2. The apparatus according to claim 1, further comprising:
a receiving stage that receives the terrestrially transmitted first portion of the satellite-transmitted signal in the first transmitted polarization and receives the terrestrially transmitted second portion of the satellite-transmitted signal in the second transmitted polarization.

3. The apparatus according to claim 1, wherein:
the first transmitted polarization is one of right-hand circular, left-hand circular, vertical, and horizontal.

4. The apparatus according to claim 1, wherein the output is located within an interior of the building.

5. The apparatus according to claim 1, wherein the output comprises at least one of a helix antenna, a crossed-dipole antenna, and a parabolic antenna.

6. The apparatus according to claim 1, further comprising:
an encoder for encoding the at least a portion of the received satellite-transmitted signal.

7. The apparatus according to claim 1, wherein the output transmits the first transmitted portion of the satellite-transmitted signal and the second transmitted portion of the satellite-transmitted signal at substantially the same radio frequency as the input receives the first and second portions of the satellite-transmitted signal.

8. The apparatus according the claim 1, further comprising:
a building physically coupled to the input and the output.

9. The apparatus according to claim 1, further comprising:
an amplifier communicatively coupled to the input for amplifying the received first and second portions of the satellite-transmitted signal.

10. The apparatus according the claim 1, wherein:
the received first and second portions of the satellite-transmitted signal includes television programming information.

11. A satellite signal relay system, the system comprising:
a terrestrial relay stage that includes:
an input for receiving a satellite-transmitted signal having at least one of a left-hand circularly polarized component and a right-hand circularly polarized component; and
an output for terrestrially wirelessly transmitting at least a portion of the received satellite-transmitted signal in at least one circular polarization; and
a receiving stage that receives the terrestrially wirelessly transmitted at least a portion of the received satellite-transmitted signal in at least one circular polarization.

12. A satellite signal relay system, the system comprising:
a terrestrial relay stage that includes:
an input for receiving a left-hand circularly polarized satellite-transmitted signal and a right-hand circularly polarized satellite-transmitted signal; and
an output for terrestrially wirelessly transmitting at least a portion of the left-hand circularly polarized satellite-transmitted signal in a circular polarization and for terrestrially wirelessly transmitting at least a portion of the right-hand circularly polarized satellite-transmitted signal in a circular polarization opposite the polarization of the terrestrially transmitted at least a portion of the left-hand circularly polarized signal; and
a receiving stage that receives the terrestrially transmitted at least a portion of the left-hand circularly polarized satellite-transmitted signal and the terrestrially transmitted at least a portion of the right-hand circularly polarized satellite-transmitted signal.

13. The satellite signal relay system according to claim 12, wherein the terrestrial relay stage further includes:
an amplifier communicatively coupled to the input for amplifying the received left-hand circularly polarized satellite-transmitted signal and the received right-hand circularly polarized satellite-transmitted signal.

14. The satellite signal relay system according to claim 12, wherein the output transmits the at least a portion of the left-hand circularly polarized satellite transmitted signal and the at least a portion of the right-hand circularly polarized satellite transmitted signal at substantially the same radio frequency as the input receives the left-hand circularly polarized satellite-transmitted signal and the right-hand circularly polarized satellite-transmitted signal.

15. The apparatus according to claim 12, wherein the output is located within an interior of a building.

16. A method for terrestrially relaying a satellite-transmitted signal, the method comprising:
receiving with a first stage, a left-hand circularly polarized satellite-transmitted signal and a right-hand circularly polarized satellite-transmitted signal; and
terrestrially wirelessly transmitting at least a portion of the left-hand circularly polarized satellite-transmitted signal in a circular polarization and for terrestrially wirelessly transmitting at least a portion of the right-hand circularly polarized satellite-transmitted signal in a circular polarization opposite the polarization of the terrestrially transmitted at least a portion of the left-hand circularly polarized signal.

17. The method according the claim 16, further comprising:
encoding at least a portion of the left-hand circularly polarized satellite-transmitted signal and at least a portion of the right-hand circularly polarized satellite-transmitted signal prior to transmitting the signal.

18. The method according the claim 16, further comprising:
amplifying at least a portion of the left-hand circularly polarized satellite-transmitted signal and at least a portion of the right-hand circularly polarized satellite-transmitted signal prior to transmitting the signal.

19. The method according the claim 16, further comprising:
receiving the terrestrially transmitted at least a portion of the left-hand circularly polarized satellite-transmitted signal and the terrestrially transmitted at least a portion of the right-hand circularly polarized satellite-transmitted signal.

20. The method according the claim 16, further comprising:
receiving a satellite-transmitted radio signal; and
terrestrially transmitting the satellite-transmitted radio signal.
